(19) United States
(12) Patent Application Publication
(10) Pub. No.: US 2020/0036654 A1
(43) Pub. Date: Jan. 30, 2020

(54) RESPONDING TO UNBLOCKING OF A SWITCH PORT

(71) Applicant: HEWLETT PACKARD ENTERPRISE DEVELOPMENT LP, Houston, TX (US)

(72) Inventors: Suganya John Bosco Sesu Annamary, Bangalore (IN); Dinesh Mandralli Channabasappa, Bangalore (IN)

(21) Appl. No.: 16/048,491

(22) Filed: Jul. 30, 2018

(51) Int. Cl. H04L 12/947; H04L 12/935; H04L 12/931; H04L 12/46

(52) U.S. Cl. CPC H04L 49/25; H04L 12/4641; H04L 49/354; H04L 49/30

(57) ABSTRACT

A switch includes a port and a processor to receive an event associated with unblocking of the port. In response to the event associated with the unblocking of the port, the processor is to wait a specified amount of time that is based on a loop detect time interval used by a loop protect process for detecting a loop in a network. After waiting the specified amount of time, the processor is to determine whether the port remains unblocked.

### BACKGROUND

A network includes switches that are used to route data communicated between devices. The data is originated by a sender device. The switch receives the data from the sender device, and forwards the received data to a recipient device (or multiple recipient devices).

### BRIEF DESCRIPTION OF THE DRAWINGS

Some implementations of the present disclosure are described with respect to the following figures.

FIG. 1 is a block diagram of a network arrangement according to some examples.

FIG. 2 is a flow diagram of a process according to some examples.

FIG. 3 is a block diagram of a switch according to some examples.

FIG. 4 is a block diagram of a storage medium storing machine-readable instructions according to some examples.

FIG. 5 is a flow diagram of a process according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A switch can refer to a network device within a network that forwards data sent by a sender device toward a recipient device (or multiple recipient devices). In some examples, a switch includes a layer 2 switch that forwards data packets (also referred to as data frames or data units) based on layer 2 addresses in the data packets. Examples of layer 2 addresses include Medium Access Control (MAC) addresses. In alternative examples, a switch includes a layer 3 router that forwards data packets based on layer 3 addresses, such as Internet Protocol (IP) addresses in the data packets.

A switch forwards data (in data packets) between a sender device and a recipient device (or multiple recipient devices) based on forwarding information (or equivalently, “routing information”) accessible by the switch. The forwarding information can include entries that map network addresses (e.g., MAC addresses or IP addresses) and/or ports to respective network paths toward the recipient device(s).

A switch can include interfaces connected to respective links, where the links can be connected to other switches or to devices (e.g., a sender device that originates data that is transmitted, or a recipient device that is a destination or target of data transmitted over a network).

A “device” can refer to any electronic device, such as any or some combination of a desktop computer, a notebook computer, a tablet computer, a smartphone, a wearable device (e.g., a smart watch, smart eyeglasses, a head-mounted device, etc.), an Internet-of-Things (IoT) device, a vehicle, a household appliance, a game appliance, and so forth.

Interfaces of a switch can also be referred to as “ports.” Generally, a port can refer to a hardware transceiver used to transmit and receive data over a corresponding network link, or can refer to a combination of the hardware transceiver and protocol layer(s) that communicate(s) data according to respective communication protocol(s).

In some cases, a port of a switch can be configured as a trunk port. A trunk port is able to carry traffic for multiple virtual local area networks (VLANs). In some examples, a trunk port is able to tag data packets using tags that identify respective VLANs. A tag includes information that uniquely identifies a respective VLAN. Tagging of data packets can be according to the Institute of Electrical and Electronics Engineers (IEEE) 802.1Q standard or another standard.

A “packet” or “data packet” can refer to any unit of data that can be conveyed over a network. A packet or data packet may also refer to a frame or data frame, a data unit, a protocol data unit, and so forth.

A Multiple VLAN Registration Protocol (MVRP) is a layer 2 protocol that provides a mechanism of dynamically propagating VLAN information from a source switch to other switches in the network. Within a layer 2 network, MVRP provides a technique to automatically dynamically share VLAN information and configure the respective VLANs. By using MVRP, once a first switch is configured with a VLAN, information of the VLAN is propagated to other MVRP-enabled switches to configure the VLAN on the other switches, such that manual configuration of the VLAN on the other switches does not have to be performed.

An incorrectly deployed network may include a loop. A loop refers to a data path that begins at a given switch and returns to the given switch. Thus, presence of a loop in the network can cause the given switch to receive a data packet that the given switch transmitted, which is undesirable due to the possibility that the given switch may continually forward data packets that the given switch has already forwarded previously.

A loop detect process can be implemented in a switch to detect presence of a loop in the network. In some examples, the loop detect process is to detect a layer 2 loop in the network.

Once loop protection is enabled on a port of a switch, the switch can transmit a loop detect packet through the port. If the switch detects receipt of the loop detect packet that the switch transmitted, then the loop detect process indicates presence of a loop in the network. The indication can be in the form of a flag or other indicator set to a specified value. In response to the indication, the switch disables (i.e., blocks) the port on which the loop detect packet was transmitted.

In some examples, to allow for the switch to respond to a network change (such as a change that causes a previously detected network loop to be removed), the switch can include a re-enable timer that is started in response to blocking of a port of the switch. The re-enable timer is set to run a specified re-enable time interval (which can be preset in the switch, configured by a network administrator or a machine or a program, or set using another technique). In response to expiration of the re-enable timer (i.e., expiration of the specified re-enable time interval), the switch re-enables (i.e., unblocks) the port that was previously blocked.

Once the port is unblocked, the loop detect process can start a transmit timer that is set to run a specified loop detect time interval (also referred to as a “transmit interval”). The loop detect time interval can be preset in the switch, configured by a network administrator or a machine or a program, or set using another technique. In response to expiration of the transmit timer (i.e., expiration of the loop detect time interval), the loop detect process transmits a loop detect packet through the unblocked port, to again check for a network loop for the port.

The above process is re-iterated every re-enable time interval, thereby potentially resulting in port unblocking every re-enable timer expiry and port blocking every transmit timer expiry.

If MVRP is enabled at the switch, the switch detects unblocking of the port (due to expiration of the re-enable timer) and can react to the unblocking of the port by learning VLAN information for the port to set up VLANs configured on the port. However, if the port is again blocked by the loop detect process in response to detecting a network loop, the previously dynamically learnt VLANs will be deleted for the port. The repeated (unnecessary) creation and deletion of VLANs of a port results in VLAN thrashing. Since creating and deleting VLANs involve usage of a processor (or processors) of the switch, VLAN thrashing can lead to heavy processor usage that can lead to reduced switch performance.

In accordance with some implementations of the present disclosure, to avoid or reduce VLAN thrashing, in response to an event associated with the unblocking of a port that was previously blocked, a switch waits a specified amount of time that is based on a loop detect time interval (e.g., the transmit interval of the transmit timer noted above) used by a loop protect process for detecting a loop in a network. After waiting the specified amount of time, the switch determines whether the port remains unblocked. In response to determining that the port remains unblocked after waiting the specified amount of time, the switch takes action to handle the event associated with unblocking of the port that was previously blocked, where the action can include learning virtual network information associated with the port according to MVRP. In response to determining that the port is blocked after waiting the specified amount of time, the switch disregards the event associated with the unblocking of the port.

Although reference is made to MVRP in examples discussed herein, it is noted that in other examples, other protocols that automatically configure virtual network information for switches of a network can be employed.

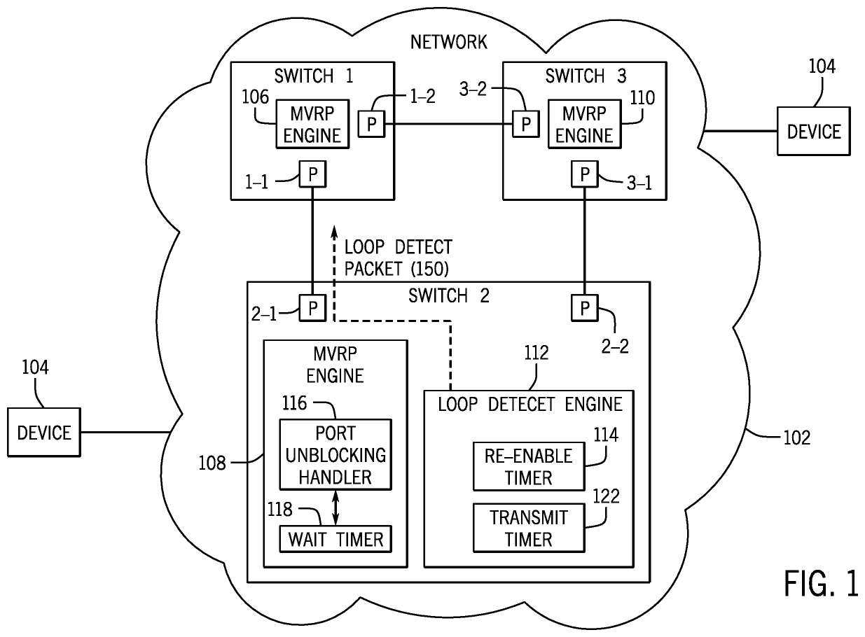

FIG. 1 is a block diagram of an example network arrangement that includes a network 102 to which are connected various devices 104. A device 104 can transmit data through the network 102 for receipt by another device 104.

The network 102 includes switches 1, 2, and 3. Although just three switches are shown in the example of FIG. 1, it is noted that the network 102 can include a different number of switches in other examples, including less than two switches or more than three switches.

Each switch has a number of ports that can connect to ports of other switches, or alternatively, can connect to devices. In the example of FIG. 1, the switch 1 includes ports 1-1 and 1-2. The switch 2 includes ports 2-1 and 2-2. The switch 3 includes ports 3-1 and 3-2. Although each switch is depicted as including two ports, it is noted that a switch can include more than two ports.

In the example of FIG. 1, the port 1-1 of the switch 1 is connected to the port 2-1 of the switch 2, the port 1-2 of the switch 1 is connected to the port 3-2 of the switch 3, and the port 2-2 of the switch 2 is connected to the port 3-1 of the switch 3.

Each of the switches 1, 2, and 3 can be an MVRP-enabled switch (in which MVRP is enabled on each port of the switches) that is capable of transmitting VLAN information to other switches and learning VLAN information received from other switches. To support MVRP, the switches 1, 2, and 3 include respective MVRP engines 106, 108, and 110.

As used here, an “engine” can refer to a hardware processing circuit, which can include any or some combination of the following: a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit.

Each MVRP engine of a switch is able to dynamically propagate VLAN information to other switches in the network 102. An MVRP engine in a switch that receives VLAN information from another switch dynamically learns information of VLANs configured on the other switch.

The switch 2 further includes a loop detect engine 112 to detect loops in the network 102. Although FIG. 1 does not show the switches 1 and 3 as including loop detect engines, it is noted that in other examples, switches 1 and 3 can also include loop detect engines.

The loop detect engine 112 provides loop protection to detect a loop in the network 102. For example, the loop detect engine 112 can transmit a loop detect packet 150 from the port 2-1. In some examples, a loop detect packet includes a Bridge Protocol Data Unit (BPDU). If the loop detect engine 112 detects receipt of the transmitted loop detect packet, then the loop detect engine 112 indicates presence of a loop in network 102, and blocks the port 2-1 on which the loop detect packet was transmitted.

Once a port is blocked, the loop detect engine 112 starts a re-enable timer 114, which runs a specified re-enable time interval. Upon expiration of the re-enable timer 114 after the re-enable timer 114 has run the specified re-enable timer interval, the loop detect engine 112 unblocks a previously blocked port. In response to the unblocking of a port, the loop detect engine 112 starts a transmit timer 122, which runs a specified transmit interval. Expiration of the transmit timer 122 causes the loop detect engine 112 to send a loop detect packet through the unblocked port, to check whether a loop is present in the network 102. If a loop is detected, then the loop detect engine 112 can again block the port that was unblocked.

The above process of port unblocking and potentially blocking a port if a loop is detected is re-iterated every re-enable time interval tracked by the re-enable timer 114.

In accordance with some implementations of the present disclosure, the switch 2 includes a port unblocking handler 116, which is able to perform specified tasks in response to a port unblocking event, which is an event associated with an unblocking of a port. In the example of FIG. 1, the port unblocking handler 116 is part of the MVRP engine 108. In other examples, the port unblocking handler 116 can be separate from the MVRP engine 108.

The port unblocking handler 116 cooperates with a wait timer 118 to prevent, during a wait time interval tracked by the wait timer 118, the MVRP engine 108 from performing an MVRP process that includes learning VLAN information of other switches on an unblocked port. In some examples, the port unblocking handler 116 can control a state of an MVRP activation indication. If the MVRP activation indication is set to an inactive state, then the MVRP engine 108 is disabled from performing an MVRP process. However, if the MVRP activation indication is set to an active state, then the MVRP engine 108 is enabled to perform an MVRP process

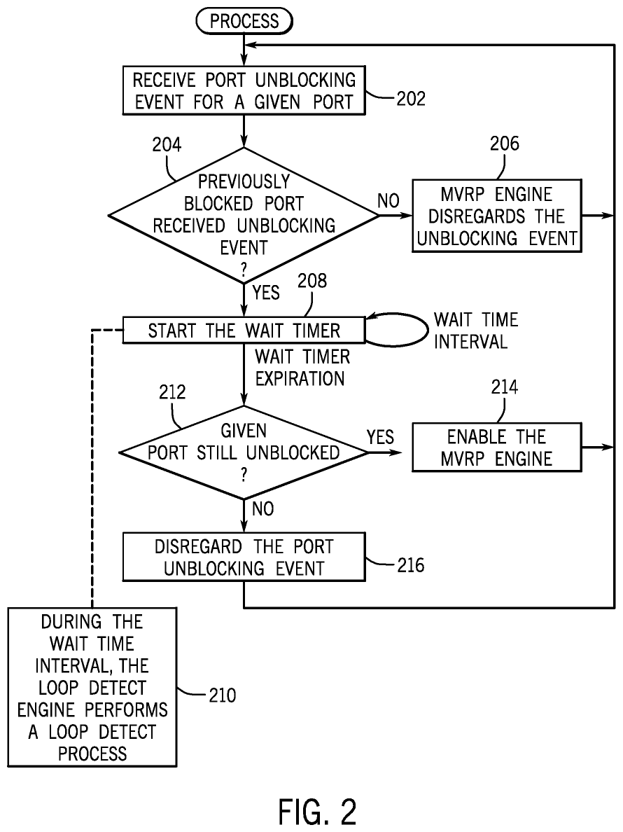

FIG. 2 is a flow diagram of a process that is performed by the switch 2 according to some examples. A port unblocking event for a given port is received (at 202) in the switch 2. For example, the port unblocking event can include the unblocking of the given port due to expiration of the re-enable timer 114 of the loop detect engine 114.

In response to the port unblocking event, the port unblocking handler 116 determines (at 204) whether the given port is a previously blocked port that received the unblocking event. If the given port is not a previously blocked that received the unblocking event (which means that the unblocking event is not due to expiration of the re-enable timer 114), then the port unblocking handler 116 the MVRP engine 108 disregards (at 206) the port unblocking event.

However, if the port unblocking handler 116 determines (at 204) that the given port is a previously blocked port that received the unblocking event, the port unblocking handler 116 starts (at 208) the wait timer 118, such as by activating a start indication (e.g., a start signal connected to an input of the wait timer 118). The wait timer 118 is configured to run a specified wait time interval. The specified wait time interval can be configured by a network administrator or a machine or a program, or can be set using another technique.

The specified wait time interval tracked by the wait timer 118 can be based on the transmit interval of the transmit timer 122. In some examples, the wait time interval can be set to be some multiple of the transmit interval, where the multiple can be any value greater than one. Stated differently, the wait time interval is based on a product of a specified constant value and the transmit interval. For example, the wait time interval can be set to be twice the transmit interval.

In further examples, the wait time interval is selected from among a value based on the product of the specified constant value and the transmit time interval, and a maximum time value indicating a maximum amount of time for the switch to wait before handling the event associated with the unblocking of the port.

During the wait time interval, the MVRP engine 108 is maintained disabled (such as by setting the MVRP activation indication to an inactive state). The wait time interval tracked by the wait timer 118 is to cause the MVRP engine 108 to not immediately respond to the received port unblocking event, but rather, to wait the wait time interval to check if the unblocked given port is again blocked before expiration of the wait time interval.

During the wait time interval after the wait timer 118 has been started, the loop detect engine 112 may perform (at 210) a loop detect process that includes sending a loop detect packet from the unblocked given port to the network 102. If the loop detect packet is received by the switch 2, then a network loop is detected and the loop detect engine 112 blocks the given port that was unblocked. However, if the loop detect engine 112 detects that there is no network loop (i.e., the loop detect packet transmitted from the given port is not received by the switch 2), then the loop detect engine 112 keeps the given port unblocked.

In response to expiration of the wait timer 118, the port unblocking handler 116 determines (at 212) whether the given port is still unblocked. If the given port remains unblocked, the port unblocking handler 116 enables (at 214) the MVRP engine 108 to perform an MVRP process.

However, if the port unblocking handler 116 determines (at 212) that the given port is blocked, then the port unblocking handler 116 disregards (at 216) the port unblocking event and maintains the MVRP engine 108 in the disabled state. This prevents the MVRP engine 108 from performing an MVRP process to learn VLAN information of other switches.

By disregarding the port unblocking event in response to the given port being blocked after unblocking, the MVRP engine 108 is prevented from learning VLAN information and updating VLAN entries in a VLAN database of the switch 2 that includes entries for VLANs. As discussed above, if the MVRP engine 108 learns VLAN information of another switch after the given port is unblocked and updates the VLAN information in the VLAN database, then a subsequent blocking of the given port would cause the MVRP engine 108 to delete the VLAN information learnt on the given port from the VLAN database. Such a process is referred to as VLAN thrashing, which is wasteful of processing and storage resources of the switch 2. Moreover, processing resources of the switch 2 are conserved by not having to respond to certain port unblocking events relating to ports that are blocked relatively soon after unblocking due to network loops. Additionally, once a VLAN is learned, the switch 2 may set up a data path for the VLAN, which is wasteful of bandwidth of the switch 2 if the VLAN is to be quickly taken down again due to a detected network loop.

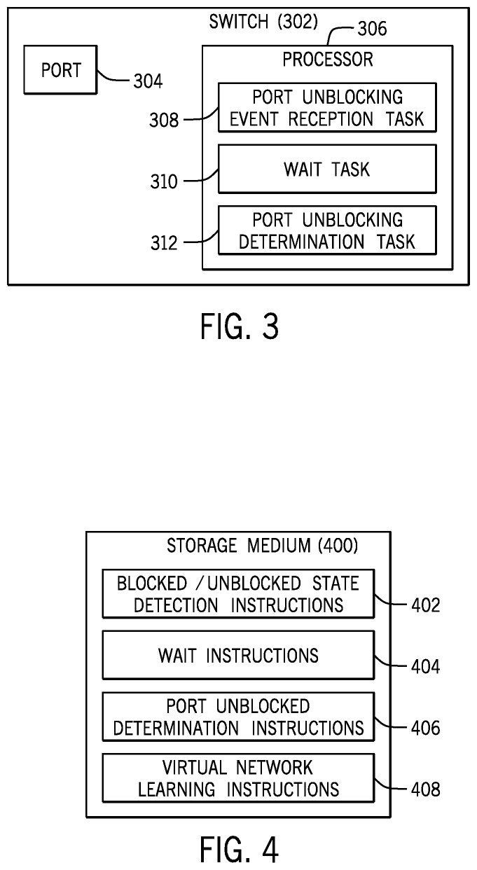

FIG. 3 is a block diagram of a switch 302 that includes a port 304 and a hardware processor 306 that can perform respective tasks. A hardware processor performing a task can refer to a single hardware processor performing the task or multiple hardware processors performing the task.

A hardware processor can include a microprocessor, a core of a multi-core microprocessor, a microcontroller, a programmable integrated circuit, a programmable gate array, or another hardware processing circuit.

The tasks that are performed by the hardware processor 306 include a port unblocking event reception task 308 that receives an event associated with unblocking of the port 304. The tasks further include a wait task 310 to, in response to the event associated with the unblocking of the port, wait a specified amount of time that is based on a loop detect time interval (e.g., a transmit interval of the transmit timer 122 of FIG. 1) used by a loop protect process for detecting a loop in a network. The tasks further include a port unblocking determination task 312 to determine, after waiting the specified amount of time, whether the port remains unblocked.

FIG. 4 is a block diagram of a non-transitory machine-readable or computer-readable storage medium 400 storing machine-readable instructions that upon execution cause a switch to perform various tasks.

The machine-readable instructions include blocked/unblocked state detection instructions 402 to detect that a port of the switch has changed from a blocked state to an unblocked state.

The machine-readable instructions further include wait instructions 404 to, in response to the detecting, wait a specified amount of time that is based on a loop detect time interval used by a loop protect process for detecting a loop in a network.

The machine-readable instructions further include port unblocked determination instructions 406 to, after waiting the specified amount of time, determine whether the port remains in the unblocked state.

The machine-readable instructions further include virtual network information learning instructions 408 to, in response to determining that the port remains in the unblocked state after waiting the specified amount of time, learn virtual network information associated with the port.

The virtual network information includes information of a VLAN (or multiple VLANs) configured on the port. The machine-readable instructions further include instructions to perform transfer of data over a virtual network (e.g., a VLAN) configured on the port according to the virtual network information.

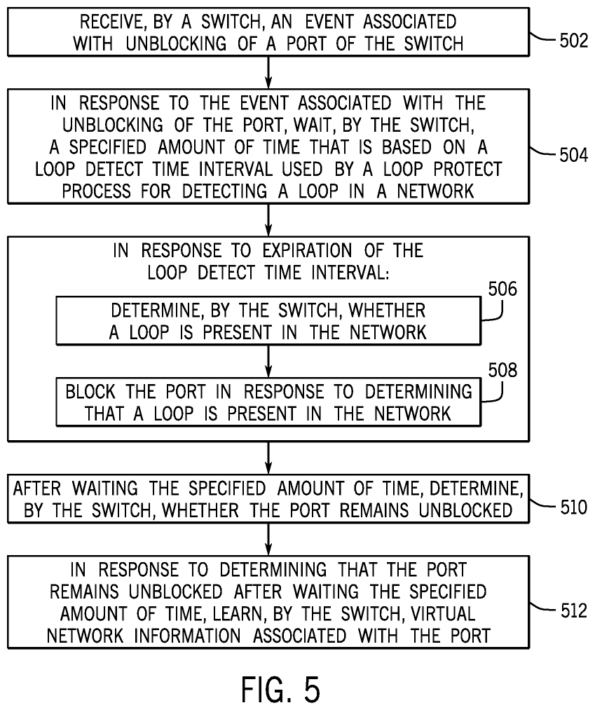

FIG. 5 is a flow diagram of a process according to some examples. The process of FIG. 5 includes receiving (at 502), by a switch, an event associated with unblocking of a port of the switch.

The process further includes, in response to the event associated with the unblocking of the port, waiting (at 504), by the switch, a specified amount of time that is based on a loop detect time interval used by a loop protect process for detecting a loop in a network.

The process further includes, in response to expiration of the loop detect time interval: determining (at 506), by the switch, whether a loop is present in the network, and blocking (at 508) the port in response to determining that a loop is present in the network.

The process further includes, after waiting the specified amount of time, determining (at 510), by the switch, whether the port remains unblocked. The process further includes, in response to determining that the port remains unblocked after waiting the specified amount of time, learning (at 512), by the switch, virtual network information associated with the port.

The storage medium 400 of FIG. 4 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site (e.g., a cloud) from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A switch comprising:
a port; and
a processor to:
receive an event associated with unblocking of the port;
in response to the event associated with the unblocking of the port, wait a specified amount of time that is based on a loop detect time interval used by a loop protect process for detecting a loop in a network; and
after waiting the specified amount of time, determine whether the port remains unblocked.

2. The switch of claim 1, wherein the processor is to:
in response to determining that the port remains unblocked after waiting the specified amount of time, learn virtual network information associated with the port.

3. The switch of claim 2, wherein the learning of the virtual network information associated with the port is according to a protocol that automatically configures virtual network information for switches of the network.

4. The switch of claim 3, wherein the protocol comprises a Multiple Virtual Local Area Network (VLAN) Registration Protocol (MVRP).

5. The switch of claim 2, wherein the processor is to:
in response to determining that the port is blocked after waiting the specified amount of time, disregard the event associated with the unblocking of the port.

6. The switch of claim 1, wherein the loop protect process is to send a loop detect packet through the port to detect a loop in the network at a time based on the loop detect time interval.

7. The switch of claim 6, wherein the loop protect process is to indicate presence of a loop in the network in response to detecting receipt of the loop detection packet by the switch.

8. The switch of claim 7, wherein the switch is to block the port in response to the indicating of the presence of a loop in the network.

9. The switch of claim 8, wherein the processor is to, after the blocking of the port in response to the indicating of the presence of a loop in the network, unblock the port responsive to expiration of a re-enable time interval.

10. The switch of claim 1, wherein the processor is to:
in response to the event, determine whether the port has changed from a blocked state to an unblocked state; and
perform the waiting and the determining of whether the port remains unblocked in response to determining that the port has changed from the blocked state to the unblocked state.

11. The switch of claim 1, wherein the specified amount of time is based on a product of a specified constant value and the loop detect time interval.

12. The switch of claim 11, wherein the specified amount of time is selected from among a value based on the product of the specified constant value and the loop detect time interval, and a maximum time value indicating a maximum amount of time for the switch to wait before handling the event associated with the unblocking of the port.

13. A non-transitory machine-readable storage medium storing instructions that upon execution cause a switch to:
detect that a port of the switch has changed from a blocked state to an unblocked state;
in response to the detecting, wait a specified amount of time that is based on a loop detect time interval used by a loop protect process for detecting a loop in a network;
after waiting the specified amount of time, determine whether the port remains in the unblocked state; and
in response to determining that the port remains in the unblocked state after waiting the specified amount of time, learn virtual network information associated with the port.

14. The non-transitory machine-readable storage medium of claim 13, wherein the virtual network information comprises information of a virtual local area network (VLAN) configured on the port.

15. The non-transitory machine-readable storage medium of claim 13, wherein the instructions upon execution cause the switch to:
perform transfer of data over a virtual network configured on the port according to the virtual network information.

16. The non-transitory machine-readable storage medium of claim 13, wherein the instructions upon execution cause the switch to:
change the port from the blocked state to the unblocked state in response to expiration of a re-enable timer.

17. The non-transitory machine-readable storage medium of claim 16, wherein the re-enable timer is defined by a Multiple Virtual Local Area Network (VLAN) Registration Protocol (MVRP).

18. The non-transitory machine-readable storage medium of claim 13, wherein the instructions upon execution cause the switch to:
in response to determining that the port has changed from the unblocked state back to the blocked state after waiting the specified amount of time, disregard the change in the port from the blocked state to the unblocked state.

19. A method comprising:
receiving, by a switch, an event associated with unblocking of a port of the switch;
in response to the event associated with the unblocking of the port, waiting, by the switch, a specified amount of time that is based on a loop detect time interval used by a loop protect process for detecting a loop in a network;
in response to expiration of the loop detect time interval:
determining, by the switch, whether a loop is present in the network, and
blocking the port in response to determining that a loop is present in the network;
after waiting the specified amount of time, determining, by the switch, whether the port remains unblocked; and
in response to determining that the port remains unblocked after waiting the specified amount of time, learning, by the switch, virtual network information associated with the port.

20. The method of claim 19, further comprising:
in response to determining that the port is blocked after waiting the specified amount of time, disregarding, by the switch, the event associated with the unblocking of the port.
